(19) United States
(12) Patent Application Publication
(10) Pub. No.: US 2015/0042072 A1
(43) Pub. Date: Feb. 12, 2015

(54) Method and Apparatus for Cold Forging Metal Tubing for Trailer Hitch Receivers and the Trailer Hitch Receiver so Formed

(71) Applicant: 792716 Ontario Inc., Windsor (CA)

(72) Inventor: Kevin Kelly, Lasalle (CA)

(21) Appl. No.: 14/457,026

(22) Filed: Aug. 11, 2014

(30) Foreign Application Priority Data
Aug. 12, 2013 (CA) 2823390

(51) Int. Cl. B21K 7/12; B60D 1/52; B21J 13/03; B21J 9/12; B21J 5/02

(52) U.S. Cl. CPC B21K 7/12; B21J 9/12; B21J 5/025; B21J 13/03; B60D 1/52
USPC 280/491.5; 72/357; 72/361; 72/360

(57) ABSTRACT

A die is adapted for forming a cold forged receiver hitch that includes an integral cold forged smooth reinforcing flange at an upper end. The die includes a top plate and a bottom plate spaced apart from the top plate along a plate axis that is perpendicular to the surfaces of the top and bottom plates. The top plate includes two transversely spaced-apart jambs within which the top plate is slidably mounted, an actuation system configured to move the top plate relative to the bottom plate along the plate axis. The bottom plate supports a bottom support plate to which a stationary mandrel is secured and an assembly of two transversely spaced-apart split cams, the split cams being transversely spaced from the stationary mandrel by a distance that is greater than the thickness of the tube out of which the receiver hitch is to be cold forged.

### CROSS REFERENCE TO RELATED APPLICATION

This application claims priority under 35 U.S.C. §119(a) to Canadian patent application No. 2,823,390, “Method and Apparatus for Cold Forging Metal Tubing for Trailer Hitch Receivers and the Trailer Hitch Receiver so Formed,” filed on Aug. 12, 2013, which is incorporated herein by reference in its entirety.

### TECHNICAL FIELD

The disclosed subject matter relates to a method for cold forming an end of a tube to provide a reinforced portion. The disclosed subject matter also relates to an apparatus for cold forming an end of a tube to provide a reinforced portion or collar. The disclosed subject matter also relates to a receiver tube construction for a trailer hitch assembly and more particularly to an elongate receiver tube for a trailer hitch assembly generally in the form of a reinforced hollow housing member, having a relatively constant, polygonal cross-section, a flat inner surface, and two ends and a reinforcing collar portion integrally attached to one end.

### BACKGROUND

In the automotive industry, vehicles are often fitted with a hitch assembly to which a trailer may be attached. Such an assembly usually includes a hitch receiver tube and a hitch bar slidably engaged within the hitch receiver tube. The hitch receiver tube, which is typically made of low carbon steel, is mounted on the vehicle frame by a suitable means such as brackets and the like and is normally provided at its terminal end (the end into which the hitch bar is inserted) with a reinforcing collar. Such a reinforcing collar can increase the strength of the tube. The reinforcing collar is welded on the bar.

Trailer hitches of the type used for conventional motor vehicles frequently have a receiver tube permanently mounted to the vehicle, generally using brackets and/or welds. These types of trailer hitches are in widespread use today, and are often used for hauling, for example, boats, travel trailers, utility trailers. The receiver tube opens toward the rear of the vehicle for receiving the hitch bar, which is a square cross-section solid bar of metal that is slid into the receiver tube. The hitch receiver tube is sized to receive the hitch bar therein.

The exposed end of the receiver tube is exposed to considerable lateral and vertical forces during use. In order to compensate for these forces, the ends of the receiver tubes have been reinforced. Such reinforcement includes the use of a reinforcement ring which is slid over the end of the receiver tube end and welded in place. Such a welded construction includes a weld bead.

Another way to reinforce the rear-facing opening of the receiver tube during fabrication of the hitch is to heat the tube to approximately 1800 degrees F., and the heated tube is then placed within a die cavity having a flared region adjacent to the terminal end of the tube. A mandrel was then inserted into the die and was used to apply pressure to the terminal end of the tube. This forced the tube material into the flared region, thereby increasing the thickness of the tube at its end.

Another method has been developed wherein the trailer hitch receiver tube end was reinforced by a metal forming process. The process is carried out with a tube stock at an elevated temperature of about 1800 degree Fahrenheit (F) and was upset to form a reinforcement bead around the entire periphery of the tube. The process is referred to as a “hot upset” operation.

Another method is a process for cold forming the ends of metal tubes to reinforce them, in which the tube is placed in a die cavity such that a portion is left outside the cavity. A mandrel is inserted into the tube. The mandrel includes a section that is adapted to bear against the portion of the tube outside of the cavity and to deform the tube. The deformation process is conducted without heating the tube and results in the tube being folded upon itself within a recess in the die cavity.

Another method is a process of creating a receiver tube having a reinforcing ring by folding an end portion of the tube stock upon itself to create the resultant reinforcing ring.

### SUMMARY

Described herein is an improved trailer hitch receiver tube of integral construction in which the receiving end is reinforced through a metal forming process; a trailer hitch receiver tube produced by a cold forged extrusion method of construction that can address many of the challenges of known designs and methods; an elongate receiver tube wherein the exposed end is reinforced by a cold forming process to form a crimped reinforcement flange thereon; a method for cold forming a crimped flange on the end of the elongate receiver tube for a trailer hitch assembly; and an improved manufacturing method and resultant receiver tube.

By one broad aspect, a hollow rectangularly-shaped housing member is provided with a flange at an end thereof, the flange comprising an integral cold forged smooth reinforcing flange at one end thereof.

By a second broad aspect, a die is provided which is adapted for forming a cold forged receiver hitch including an integral cold forged smooth reinforcing flange at an end thereof, the die comprising a top plate, the top plate comprising two transversely-spaced-apart jambs within which the top plate is slidably mounted, means for moving the top plate vertically upwardly and downwardly and a forming cavity at the bottom of the top plate; and a bottom plate, the bottom plate supporting a bottom support plate, to which a stationary mandrel is secured and an assembly of two transversely-spaced-apart split cams, the split cams being transversely spaced from the stationary mandrel by a distance which is greater than the thickness of the tube out of which the receiver hitch is to be cold forged.

By a third broad aspect, a die is provided which is specially adapted for forming a cold forged receiver hitch including an integral cold forged smooth reinforcing flange at an end thereof, the die comprising a top plate, the top plate comprising two transversely-spaced-apart jambs within which the top plate is slidably mounted, and a forming cavity at the bottom of the top plate; and a bottom plate, the bottom plate supporting a bottom support plate to which a stationary mandrel is secured, and an assembly of two transversely-spaced-apart split cams, the split cams being transversely spaced from the stationary mandrel by a distance which is greater than the thickness of the tube out of which the receiver hitch is to be cold forged; and means for providing relative vertical movement between the top plate and the bottom plate so that, when a tube is placed on the stationary mandrel between the split cam assembly, the forming cavity compressedly engages an extension at the upper end of the tube, thereby causing outward folding of that extension to form an integral cold forged smooth reinforcing flange at an upper end thereof.

By a fourth broad aspect, a method is provided for providing a cold forged receiver hitch including an integral cold forged smooth reinforcing flange at an upper end thereof, comprising the steps of: a) providing an elongated hollow tube having a substantially uniform wall thickness; b) providing a die defining a forming cavity specially structured and arranged to form an integral rolled smooth cold forged reinforcing flange at an upper end of the tube; c) providing the die with supporting structure to support both an inner surface of the elongated hollow tube and the outer surface of the elongated hollow tube; d) placing the elongated hollow tube on that supporting structure, with an upper end of the elongated hollow tube facing towards the forming cavity; and g) engaging the forming cavity with the upper end of the elongated hollow tube under pressure thereby causing cold outward deformation of the upper end of the elongated hollow tube, thereby to form the integral cold forged smooth reinforcing flange at an upper end thereof.

By a fifth broad aspect, a method is provided for providing a cold forged receiver hitch including an integral cold forged smooth reinforcing flange at an upper end thereof, comprising the steps of: a) providing an elongated hollow tube having a substantially uniform wall thickness; b) providing a two part die, the two parts being relatively vertically movable between one another; defining a forming cavity on one of the two dies which is specially structured and arranged to form an integral rolled smooth cold forged reinforcing flange at an upper end of the elongated hollow tube; c) providing the two part die with supporting structure for rigidly supporting both an inner surface of the elongated hollow tube and an outer surface of the elongated hollow tube, and for substantially preventing movement of the elongated hollow tube; d) placing the elongated hollow tube on that supporting structure, and facing towards the forming cavity; g) providing means for relative vertical movement under pressure between two die parts of the two part die; and h) engaging, by such relative vertical movement under pressure between two die parts of the two part die, the forming cavity with the upper end of the elongated hollow tube, thereby causing cold outward deformation of the upper end of the elongated hollow tube, and thus to form the integral cold forged smooth reinforcing flange at an upper end thereof.

By one feature of the first aspect, the dimensions of the integral cold forged rolled smooth reinforcing flange of the receiver hitch are as follows: height, about 0.15 inches and overhang over the walls of the receiver hitch, about 0.15 inches.

By a first feature of the second and third aspects, the top plate includes two transversely-spaced-apart guide jambs.

By a second feature of the second and third aspects, the top plate includes two transversely-spaced-apart guide jambs and actuator means below the top plate which are structured and arranged to move the top plate vertically downwardly and upwardly, the top plate being guided in such movement by the guide jambs.

By a third feature of the second and third aspects, the top plate includes two transversely-spaced-apart guide jambs and actuator means below the top plate which are structured and arranged to move vertically downwardly and upwardly, and thereby to move the top plate vertically downwardly and upwardly, the top plate being guided in such movement by the guide jambs, and two transversely-spaced-apart guide rods for guiding the actuator means to move vertically downwardly and upwardly.

By a first variation of the first, second and third features of the second and third aspects, the top plate includes a coining plate secured to the bottom thereof.

By a second variation of the first, second and third features of the second and third aspects, the bottom plate includes a coining plate secured to the top thereof, the coining plate being structured and arranged to assure that the stationary mandrel maintains tight inside and outside tolerances of the integral rolled smooth reinforcing flange.

By a third variation of the first, second and third features of the second and third aspects, the actuator means comprises hydraulic cylinders.

By a fourth feature of the second and third aspects, and of the variations thereof, the forming cavity is secured to the approximate mid portion of the top plate, and the bottom support plate is secured to the approximate mid portion of the bottom plate.

By a first feature of the fourth and fifth method aspects, the step of providing an elongated hollow tube having a substantially uniform wall thickness comprises providing a hollow rectangularly-shaped tube.

By a second feature of the fourth and fifth method aspects, the step of providing an elongated hollow tube having a substantially uniform wall thickness comprises providing a hollow rectangularly-shaped tube, and the step of providing the die with supporting structure to support an inner surface of the elongated hollow tube comprises providing an upstanding mandrel onto which the hollow rectangularly-shaped tube is placed.

By a third feature of the fourth and fifth method aspects, the step of providing an elongated hollow tube having a substantially uniform wall thickness comprises providing a hollow rectangularly-shaped tube, the step of providing the die with supporting structure to support an inner surface of the elongated hollow tube and to support the outer surface of the hollow rectangularly-shaped tube comprises providing an upstanding mandrel onto which the hollow rectangularly-shaped tube is placed, and providing two laterally-spaced-apart split cams which are structured and arranged to be spaced from the upstanding mandrel by a distance which is more than the thickness of the hollow rectangularly-shaped tube.

By a third feature of the fifth method aspect, the step of providing the two part die comprises providing a pair of die halves which are structured and arranged to be movable relative to one another along a plane which is aligned with the longitudinal axis of the hollow rectangularly-shaped tube.

By a fourth feature of the fourth and fifth method aspects, the step of providing means for relative vertical movement under pressure between the two part die comprises providing hydraulic cylinder means.

Because the receiver hitch is not formed by welding, heat affected zones are not formed in the material of the receiver hitch. Further, because nothing is being welded to form the receiver hitch, there is no issue with gaps that can form in a seal between welded parts, and thus corrosion of the entire structure is reduced because water and salt would not be able to accumulate within such gaps. There are no weld beads or joints formed in the receiver hitch, and thus, corrosion is reduced. The appearance of the receiver hitch is one of a unitary design, and thus is pleasing to look at.

The receiver hitch is a unitary design, and thus only one component needs to be manufactured, transported, handled, and formed.

The receiver hitch is formed by a cold forging method; thus, the step of heating before forming is not needed, which reduces the time and cost for producing the receiver hitch. Additionally, challenges, such as carburization, deposit formation, reduction in structural integrity, and increase in weakness, that can arise by heating can be avoided by using a cold forging method.

The cold forging method reduces problems with folding in a wrong direction, or in multiple directions, creating laps, or sticking of the tube to the walls. The die is designed in a manner that reduces vulnerability to exploding.

### DESCRIPTION OF THE DRAWINGS

Throughout the drawings, corresponding reference numbers indicate like or corresponding parts.

FIG. 1 is a vertical cross-section showing the assembly, in its open condition, of the two-part die of one implementation.

FIG. 2 is a vertical cross-section showing the assembly, in its closed condition, of the two-part die of one implementation.

FIG. 3 is another view, in a vertical cross-section showing the assembly, in its closed condition, of the two-part die of one implementation.

FIG. 4 is a vertical cross-section of the two-part die of one implementation shown in its open condition which has received the hollow rectangularly-shaped tube to be formed into a cold forged receiver hitch including an integral cold forged smooth reinforcing flange at an upper end thereof.

FIG. 5 is a vertical cross-section of the two-part die of one implementation shown in its closed condition which has received the hollow rectangularly-shaped tube to be formed into a cold forged receiver hitch including an integral cold forged smooth reinforcing flange at an upper end thereof.

FIG. 6 is an enlarged inset of the vertical cross-section of the two-part die of one implementation in FIG. 5 shown in its open condition, which has received the hollow rectangularly-shaped tube, and shows a preliminary step in the forming of the receiver hitch including a cold forged integral smooth reinforcing flange at an upper end thereof.

FIG. 7 is an isometric view of the receiver hitch including a cold forged integral smooth reinforcing flange at an upper end thereof of another implementation.

FIG. 8 is a vertical cross-section of the receiver hitch including a cold forged integral smooth reinforcing flange at an upper end thereof of another implementation shown in FIG. 7.

FIG. 9 is a top plan view of the receiver hitch including a cold forged integral smooth reinforcing flange at an upper end thereof of another implementation shown in FIG. 7.

### DETAILED DESCRIPTION

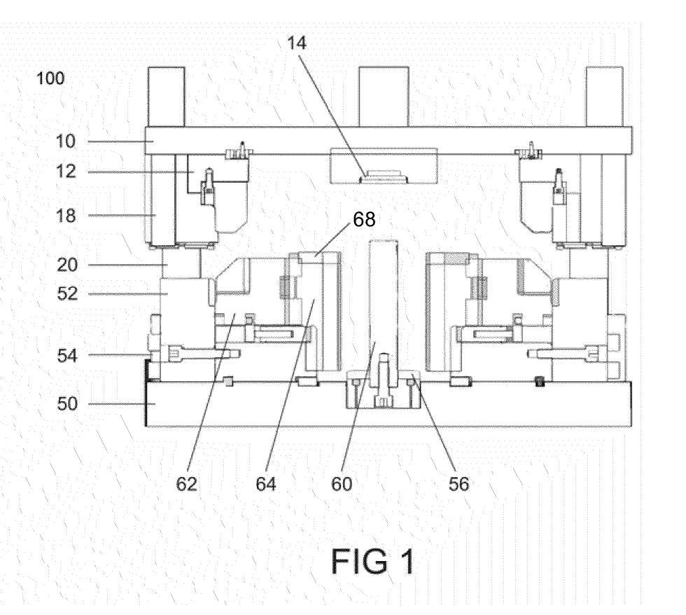

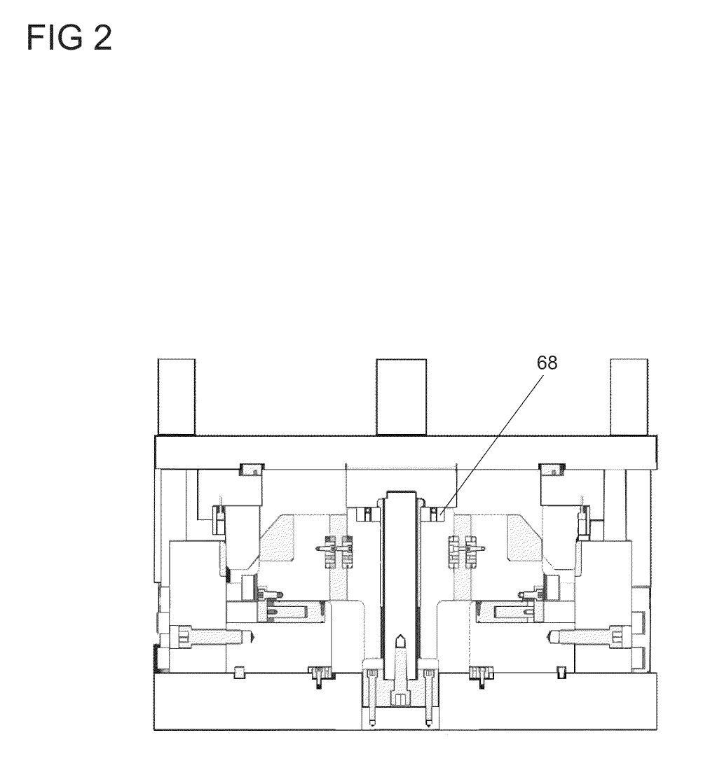

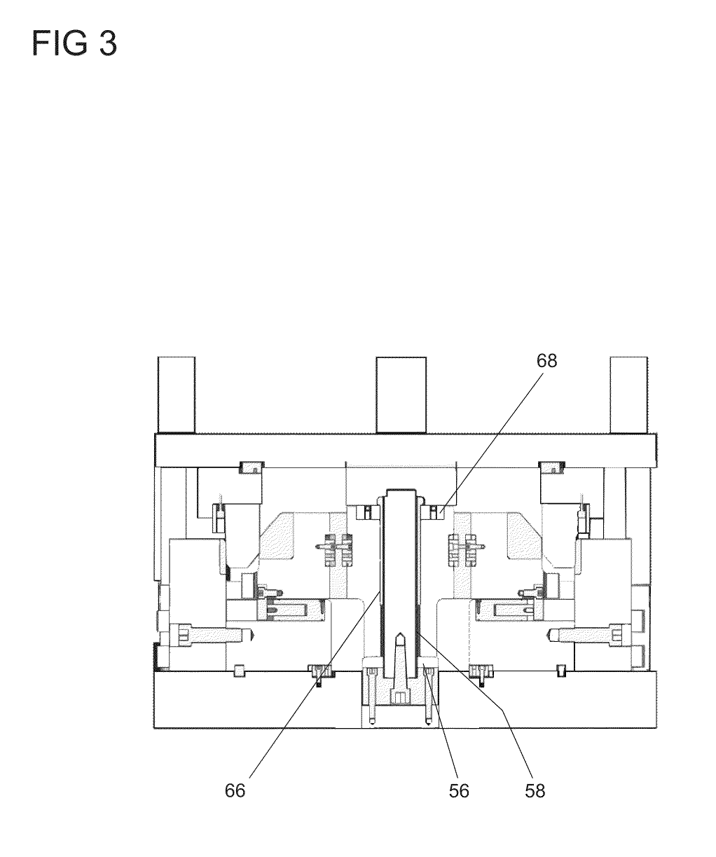

FIGS. 1 TO 5

As seen in FIGS. 1 to 5, in some implementations, a die 100 includes a top plate 10 and a bottom plate 50.

Top plate 10 is slidably mounted within two transversely-spaced-apart guide jambs 12. This slidable mounting permits access into the interior of the die 100 for the purpose of inserting the hollow rectangularly-shaped tube which is to be formed with an integral cold forged smooth reinforcing flange at one end thereof. The top plate 10 is provided with a forming cavity member 14.

In order to provide relative vertical movement of the top plate 10 and the bottom plate 50, an actuation system including two transversely-spaced-apart guide rods 18 slidably support two mechanical dwell cam actuators 20. Mechanical dwell cam actuators 20 are disposed vertically below the top plate 10. In this implementation, actuation of the dwell cams mounted to top die causes the top plate 10 to which they are connected to be urged downwardly under pressure to meet portions of the bottom plate 50. The actuators 20 can include one or more hydraulic cylinders.

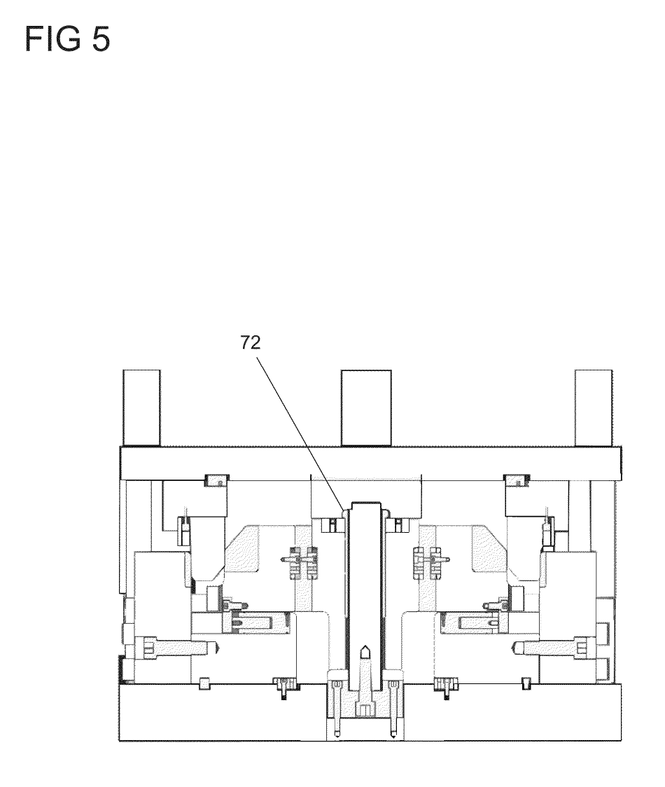

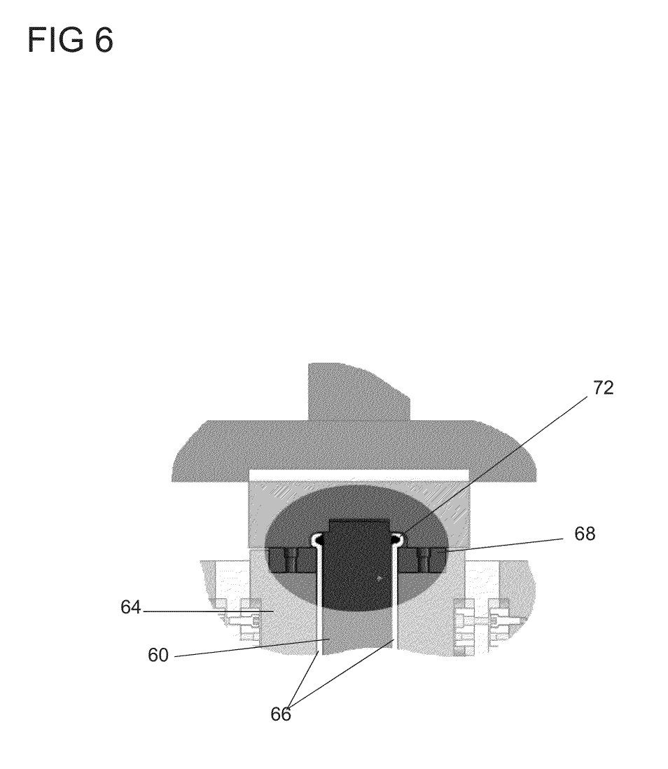

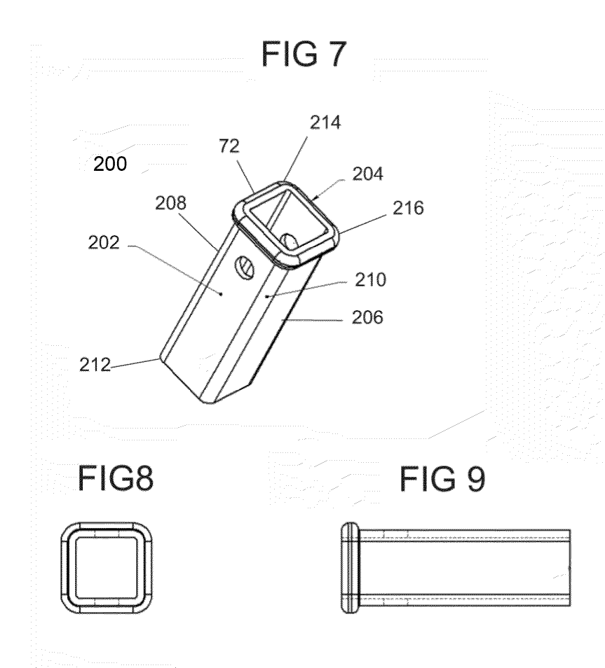

The bottom plate 50 is provided with two upstanding transversely-spaced-apart bases 52, which hold, and support, two upstanding transversely-spaced-apart guide rods 54. A bottom support plate 56 is secured at about the mid-portion of the bottom plate 50. A stationary mandrel 60 is secured to the bottom support plate 56. The bottom plate 50 also supports a cam assembly 62 comprising two transversely-spaced-apart split cams 64. The cam assembly 62 is mounted so as to provide a space of the cams 64 from the stationary mandrel 60 which is greater than the thickness of the walls of the hollow rectangularly-shaped tube 66 (see FIG. 6) which is to be formed into the receiver hitch which includes a cold forged integral cold forged smooth reinforcing flange at an upper end thereof (see FIG. 7). The split cam assembly 62 is provided with a coining plate 68. Thus, the cam assembly 62, the stationary mandrel 60, and the coining plate 68 support and maintain the inner and the outer dimensions of the hollow rectangularly-shaped tube 66. High adjusting plates 58 are secured transversely on the inner side of the split cams 64.

The relative vertical movement between the top plate 10 and the bottom plate 50 happens along a vertical direction that is perpendicular to the surfaces of the top plate 10 and the bottom plate 50, and the guide rods 18, the bases 52, the guide rods 54, and the cams 64 are transversely spaced apart in a direction that is transverse to this vertical direction. The hollow tube 66 extends generally along a longitudinal axis that is parallel with the vertical direction. The relative movement between the top plate 10 and the bottom plate 50 can happen along a direction other than a vertical direction, such as a general die direction. In this case, the transverse direction would be perpendicular to the general die direction and the hollow tube 66 would extend along the longitudinal axis, which would be parallel with the general die direction.

### Method of the Production of the Cold Forged Receiver Hitch

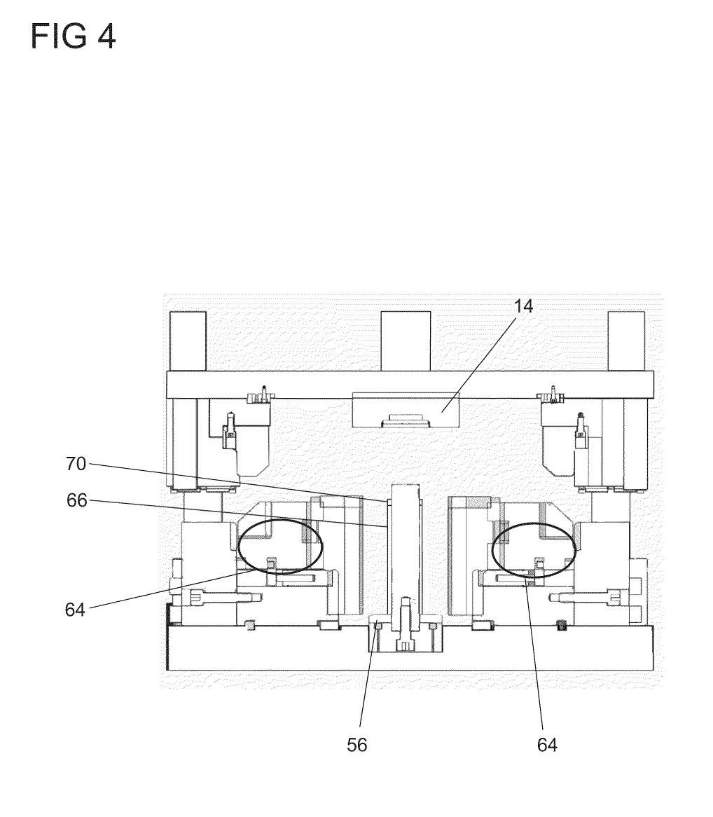

As seen in FIG. 4, the hollow rectangularly-shaped tube 66 has been placed on the stationary mandrel 60 and between the two transversely-spaced-apart split cams 64. The two mechanical dwell cam actuators 20 are actuated to cause the top plate 10 to be urged downwardly to meet the extension 70 of the hollow rectangularly-shaped tube 66. The extension 70 is thus caused to fold over the upper end of the hollow rectangularly-shaped tube 66 to form the integral, rolled, smooth reinforcing cold forged flange 72 (see FIG. 7) of the receiver hitch 200 (see FIG. 7).

Thus it is seen that the stationary mandrel 60 and the two transversely-spaced-apart split cams 64 support and maintain the inner and the outer dimensions of the hollow rectangularly-shaped tube 66 which has been formed into the integral, rolled, smooth reinforcing cold forged flange 72 (see FIG. 7) of the receiver hitch 200 (see FIG. 7). The coining plate 68 maintains the tight tolerances of the hollow rectangularly-shaped tube 66 which has been formed into the integral, rolled, smooth reinforcing cold forged flange 72 (see FIG. 7) of the receiver hitch 200 (see FIG. 7). The stationary mandrel 60 holds the formed material from flowing too far inward, thereby creating a flattened (non-sharp) state at the inner end of the hollow rectangularly-shaped tube 66.

FIGS. 7 to 9

As seen in FIGS. 7 to 9, in some implementations, the receiver hitch 200 is formed from a hollow rectangularly-shaped tube 66. The receiver hitch 200 has two side walls 202, 204, a front wall 206, a rear wall 208 and four corner walls 210, 212, 214 and 216. Corner wall 210 is connected to walls 206 and 202; corner wall 212 is connected to walls 202 and 208; corner wall 214 is connected to walls 208 and 204; and corner wall 216 is connected to walls 204 and 206. Thus receiver hitch 200 is a modified hollow rectangularly-shaped tube.

Receiver hitch 200 includes an integral, rolled, smooth reinforcing cold forged flange 72 which meets tight dimensional dimensions. In some implementations, the integral, rolled, smooth reinforcing cold forged flange 72 has the following dimensions: height, about 0.15 inches below the upper edge of the receiver hitch 200 and overhang over the walls of the receiver hitch 200 by about 0.15 inches.

Other implementations are within the scope of the following claims.

What is claimed is:

1. A die that is adapted for forming a cold forged receiver hitch including an integral cold forged smooth reinforcing flange at an upper end thereof, the die comprising:
a. a top plate, the top plate comprising two transversely-spaced-apart jambs within which the top plate is slidably mounted, an actuation system configured to move the top plate vertically downwardly and upwardly and a forming cavity at the bottom of the top plate; and
b. a bottom plate, the bottom plate supporting a bottom support plate, to which a stationary mandrel is secured and an assembly of two transversely-spaced-apart split cams, the split cams being transversely spaced from the stationary mandrel by a distance which is greater than the thickness of the tube out of which the receiver hitch is to be cold forged.

2. The die of claim 1, wherein the forming cavity is secured to a mid portion of the top plate and wherein the bottom support plate is secured to a mid portion of the bottom plate.

3. The die of claim 1, further comprising a coining plate secured to the top of the bottom plate.

4. The die of claim 3, wherein the coining plate is structured and arranged to assure that the stationary mandrel maintains tight inside and outside tolerances of the integral rolled smooth reinforcing flange.

5. The die of claim 1, wherein the actuation system is below the top plate, the actuation system being structured and arranged to move the top plate vertically downwardly and upwardly, the top plate being guided in such movement by guide jambs.

6. The die of claim 5, further comprising two transversely-spaced-apart guide rods for guiding the actuation system to move vertically downwardly and upwardly.

7. The die of claim 6, wherein the actuation system comprises one or more hydraulic cylinders.

8. A method for providing a cold forged receiver hitch including an integral cold forged smooth reinforcing flange at an upper end thereof, the method comprising:
a. providing an elongated hollow tube having a uniform wall thickness;
b. providing a die defining a forming cavity specially structured and arranged to form an integral rolled smooth cold forged reinforcing flange at an upper end of the tube;
c. providing the die with a supporting structure to support both an inner surface of the elongated hollow tube and the outer surface of the elongated hollow tube;
d. placing the elongated hollow tube on that supporting structure, with an upper end of the elongated hollow tube extending along the supporting structure and facing towards the forming cavity; and
e. engaging the forming cavity with the upper end of the elongated hollow tube under pressure;
f. thereby causing cold outward deformation of such extension and thus, to form the integral cold forged smooth reinforcing flange at an upper end thereof.

9. The method of claim 8, wherein providing an elongated hollow tube having a uniform wall thickness comprises providing a hollow tube.

10. The method of claim 8, wherein providing the die with a supporting structure to support an inner surface of the elongated hollow tube comprises providing an upstanding mandrel onto which the hollow tube is placed.

11. The method of claim 8, further comprising providing two laterally-spaced-apart split cams which are structured and arranged to be spaced from the upstanding mandrel by a distance which is more than the thickness of the hollow tube.

12. The method of claim 8, further comprising providing a pair of die halves which are structured and arranged to be movable relative to one another along a plane which is aligned with the longitudinal axis of the hollow tube.

13. The method of claim 12, wherein providing the pair of die halves for relative movement between the two die halves comprises providing one or more hydraulic cylinders.

14. A hollow rectangularly-shaped trailer hitch receiver having a flange at an upper end thereof, the reinforced flange comprising an integral cold forged smooth reinforcing flange at one end thereof.

15. The hollow rectangularly-shaped trailer hitch receiver of claim 14, wherein the dimensions of the integral cold forged rolled smooth reinforcing flange of the receiver hitch are as follows: height, about 0.15 inches below the upper edge of the receiver hitch, and overhang over the walls of the receiver hitch, about 0.15 inches.
